(19) United States
(12) Patent Application Publication
(10) Pub. No.: US 2025/0363738 A1
(43) Pub. Date: Nov. 27, 2025

(54) POINT CLOUD PROCESSING APPARATUS, POINT CLOUD PROCESSING SYSTEM, DATA PROCESSING METHOD, AND NON-TRANSITORY COMPUTER READABLE MEDIUM

(71) Applicant: NEC Corporation, Tokyo (JP)

(72) Inventors: Tatsuya FUJIMOTO, Tokyo (JP); Junichi ABE, Tokyo (JP); Hidemi NOGUCHI, Tokyo (JP); Yoshimasa ONO, Tokyo (JP)

(73) Assignee: NEC Corporation, Tokyo (JP)

(21) Appl. No.: 19/211,470

(22) Filed: May 19, 2025

(30) Foreign Application Priority Data
May 27, 2024 (JP) 2024-085772

(51) Int. Cl. G06T 17/05

(52) U.S. Cl. CPC G06T 17/05

(57) ABSTRACT

A point cloud processing apparatus according to the present disclosure is a point cloud processing apparatus that includes an acquisition unit that acquires first point cloud data generated by measuring a space including a moving object for a predetermined period, an estimation unit that estimates speed information of the moving object, based on second point cloud data constituting the moving object, the second point cloud data being included in the first point cloud data, and a correction unit that corrects a position of the second point cloud data using the speed information and difference information between a time when the second point cloud data is generated and a reference time.

### INCORPORATION BY REFERENCE

This application is based upon and claims the benefit of priority from Japanese patent application No. 2024-085772, filed on May 27, 2024, the disclosure of which is incorporated herein in its entirety by reference.

### TECHNICAL FIELD

The present disclosure relates to a point cloud processing apparatus, a point cloud processing system, a data processing method, and a program.

### BACKGROUND ART

As a sensing device that creates a three-dimensional (3D) map, Light Detection and Ranging (LiDAR) is known. The LiDAR measures a distance to an object existing in the surroundings using light. The LiDAR generates a 3D map using point cloud data obtained as a measurement result.

Patent Literature 1 discloses a configuration example of an optical distance measuring apparatus that measures a distance to a measurement target. The optical distance measuring apparatus disclosed in Patent Literature 1 measures the distance to the measurement target, using an optical coherent method.

Patent Literature 1: International Patent Publication No. WO2021/044534

### SUMMARY

A measurement target of which a distance is measured using an optical distance measuring apparatus includes a moving object. However, in a case where the optical distance measuring apparatus disclosed in Patent Literature 1 is used, measurement for a moving object of which a distance changes as time elapses is not considered. Therefore, there is a problem in that a shape indicated by point cloud data of the moving object cannot accurately indicate a shape of the moving object.

An example object of the present disclosure is to provide a point cloud processing apparatus, a point cloud processing system, a data processing method, and a program that can indicate a shape of a moving object.

A point cloud processing apparatus according to an example aspect of the present disclosure includes acquisition means for acquiring first point cloud data generated by measuring a space including a moving object for a predetermined period, estimation means for estimating speed information of the moving object, based on second point cloud data constituting the moving object, the second point cloud data being included in the first point cloud data, and a correction unit that corrects a position of the second point cloud data using the speed information and difference information between a time when the second point cloud data is generated and a reference time.

A point cloud processing system according to an example aspect of the present disclosure includes a point cloud generation apparatus that generates first point cloud data by measuring a space including a moving object for a predetermined period and a point cloud processing apparatus that acquires the first point cloud data, estimates speed information of the moving object based on second point cloud data included in the first point cloud data that is the second point cloud data constituting the moving object, and corrects a position of the second point cloud data, using the speed information and difference information between a time when the second point cloud data is generated and a reference time.

A data processing method according to an example aspect of the present disclosure includes acquiring first point cloud data generated by measuring a space including a moving object for a predetermined period, estimating speed information of the moving object, based on second point cloud data constituting the moving object, the second point cloud data being included in the first point cloud data, and correcting a position of the second point cloud data using the speed information and difference information between a time when the second point cloud data is generated and a reference time.

A program according to an example aspect of the present disclosure causes a computer to acquire first point cloud data generated by measuring a space including a moving object for a predetermined period, estimate speed information of the moving object, based on second point cloud data constituting the moving object, the second point cloud data being included in the first point cloud data, and correct a position of the second point cloud data using the speed information and difference information between a time when the second point cloud data is generated and a reference time.

According to the present disclosure, it is possible to provide a point cloud processing apparatus, a data processing method, and a program that can indicate a shape of a moving object.

### BRIEF DESCRIPTION OF DRAWINGS

The above and other aspects, features, and advantages of the present disclosure will become more apparent from the following description of certain example embodiments when taken in conjunction with the accompanying drawings, in which:

FIG. 1 is a diagram illustrating a configuration example of a point cloud processing apparatus;

FIG. 2 illustrates a flow of point cloud data correction processing, executed by the point cloud processing apparatus;

FIG. 3 is a diagram illustrating a configuration example of a point cloud processing system;

FIG. 4 is a diagram illustrating a configuration example of a point cloud generation apparatus;

FIG. 5 is a diagram illustrating power spectra of an optical signal transmitted from a transmission unit and an optical signal received by a reception unit;

FIG. 6 is a diagram illustrating a configuration example of the point cloud processing apparatus;

FIG. 7 illustrates point cloud data of a stationary object and point cloud data of a moving object;

FIG. 8 illustrates a person and a vehicle as moving objects;

FIG. 9 illustrates that a vehicle and a person are included in a predetermined region;

FIG. 10 illustrates the point cloud data of the moving object;

FIG. 11 illustrates an example in which the point cloud data of the moving object is generated using the plurality of point cloud generation apparatuses;

FIG. 12 illustrates point cloud data in which point clouds measured from a time t (n−k) to a time t (n) are stacked;

FIG. 13 is a diagram illustrating a state where the moving object moves;

FIG. 14 illustrates a change in a moving speed illustrated in FIG. 13 as a graph; and

FIG. 15 is a block diagram illustrating a configuration example of the point cloud processing apparatus or the like.

### EXAMPLE EMBODIMENT

### First Example Embodiment

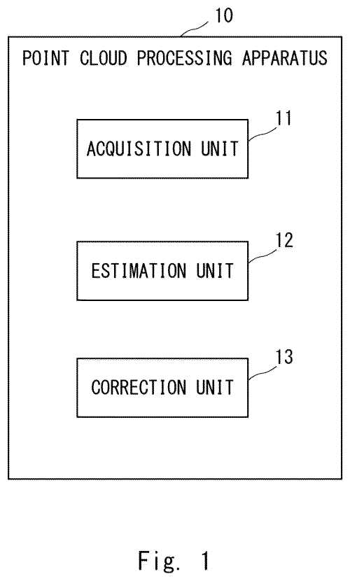

A configuration, an operation, and the like of the present disclosure will be described with reference to the drawings. FIG. 1 is a diagram illustrating a configuration example of a point cloud processing apparatus 10. The point cloud processing apparatus 10 may be a computer apparatus that operates in a case where a processor executes a program stored in a memory.

The point cloud processing apparatus 10 includes an acquisition unit 11, an estimation unit 12, and a correction unit 13. The acquisition unit 11, the estimation unit 12, and the correction unit 13 may be software components or modules whose processing is carried out by causing the processor to execute the program stored in the memory. Alternatively, the acquisition unit 11, the estimation unit 12, and the correction unit 13 may be hardware components such as circuits or chips.

The acquisition unit 11 may be used as means for acquiring information. The estimation unit 12 may be used as means for estimating information. The correction unit 13 may be used as means for correcting information.

The acquisition unit 11, the estimation unit 12, and the correction unit 13 may be provided in one point cloud processing apparatus 10 or may be dispersedly disposed in two or more computer apparatuses. That is, the point cloud processing apparatus 10 may be a point cloud processing system including the two or more computer apparatuses.

The acquisition unit 11 acquires first point cloud data generated by measuring a space including a moving object for a predetermined period. The moving object may include, for example, a vehicle, a pedestrian, or the like. The space including the moving object may be, for example, a space that can be measured by an apparatus that generates the first point cloud data. The apparatus that generates the first point cloud data may be a distance measuring apparatus using an optical signal or a sensor apparatus. The first point cloud data includes distance information from the apparatus that generates the first point cloud data to the object existing in the space. The first point cloud data may be, for example, three-dimensional data representing a position of the object existing in the space using coordinates on a predetermined coordinate axis. The first point cloud data is a set of points on a surface of the object. The first point cloud data indicates a shape of the object.

In a case where the point cloud processing apparatus 10 includes the apparatus that generates the first point cloud data, the acquisition unit 11 acquires the first point cloud data, without via a network or the like. In a case where the apparatus that generates the first point cloud data is an apparatus different from the point cloud processing apparatus 10, the acquisition unit 11 acquires the first point cloud data from the apparatus that generates the first point cloud data, via the network or the like. Acquiring may be rephrased as receiving.

The estimation unit 12 estimates speed information of the moving object, based on second point cloud data constituting the moving object. The second point cloud data is point cloud data included in the first point cloud data. The second point cloud data is point cloud data indicating a position of a surface of the moving object. The second point cloud data indicates the shape of the moving object.

The speed information may be associated with each point constituting the second point cloud data. For example, the estimation unit 12 may estimate an average value, a maximum value, or a minimum value of a speed associated with each point constituting the second point cloud data, as the speed information of the second point cloud data. Alternatively, the estimation unit 12 may estimate the speed information of the second point cloud data, using a movement amount of the second point cloud data in a predetermined period.

The correction unit 13 corrects a position of the second point cloud data, using the speed information of the second point cloud data and difference information between a time when the second point cloud data is generated and a reference time. Correcting the position of the second point cloud data may be correcting a position of each point constituting the second point cloud data.

The second point cloud data includes a plurality of points measured at different timings. Therefore, correcting the position of the second point cloud data by the correction unit 13 may be, for example, moving the position of each point constituting the second point cloud data, by the correction unit 13, to a position in a case of being measured at substantially the same time. Substantially the same time may have a predetermined time width in a case where a predetermined time is added to or a predetermined time is subtracted from a time to be a reference.

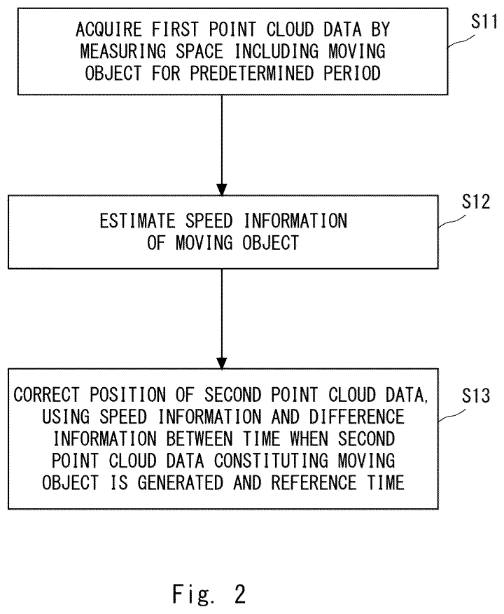

Subsequently, a data processing method executed by the point cloud processing apparatus 10 will be described. FIG. 2 illustrates a flow of point cloud data correction processing, executed by the point cloud processing apparatus 10. First, the acquisition unit 11 acquires the first point cloud data generated by measuring the space including the moving object for the predetermined period (S11). Next, the estimation unit 12 estimates the speed information of the moving object, based on the second point cloud data constituting the moving object (S12). The second point cloud data is included in the first point cloud data. Next, the correction unit 13 corrects the position of the second point cloud data, using the speed information and the difference information between the time when the second point cloud data is generated and the reference time (S13).

As described above, the point cloud processing apparatus 10 corrects the position of the second point cloud data constituting the moving object, using the speed information of the moving object and the difference information between the time when the second point cloud data is generated and the reference time. As a result, the position of the second point cloud data measured for the predetermined period is corrected to a position at a specific time. As a result, the shape of the second point cloud data indicating the moving object is clearly indicated.

### Second Example Embodiment

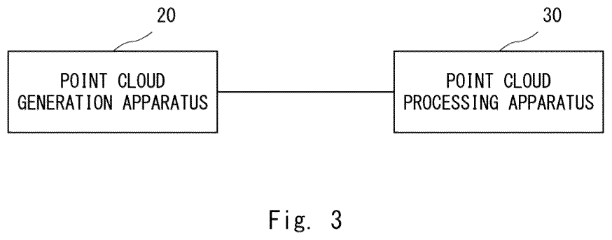

Subsequently, a configuration example of a point cloud processing system will be described with reference to FIG. 3. The point cloud processing system in FIG. 3 includes a point cloud generation apparatus 20 and a point cloud processing apparatus 30. The point cloud generation apparatus 20 may be, for example, a distance measuring apparatus that measures a distance to a measurement target. Furthermore, the point cloud generation apparatus 20 may be an optical distance measuring apparatus that measures the distance to the measurement target using an optical signal. The point cloud generation apparatus 20 may be, for example, a LiDAR apparatus.

The point cloud generation apparatus 20 and the point cloud processing apparatus 30 may transmit or receive data via a network. The network may be, for example, an internet protocol (IP) network.

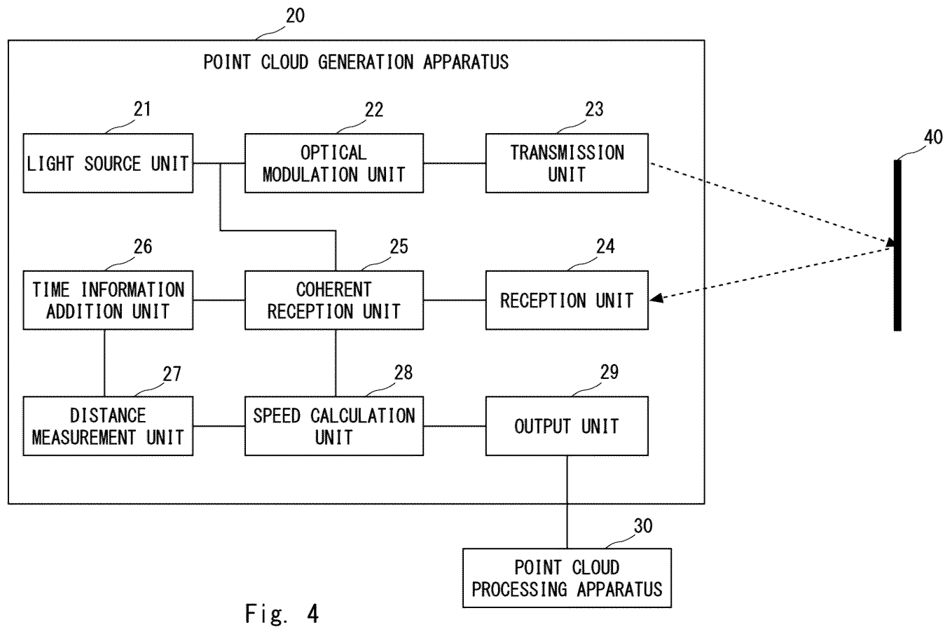

Subsequently, the point cloud generation apparatus 20 will be described. FIG. 4 illustrates a configuration example of the point cloud generation apparatus 20. The point cloud generation apparatus 20 may be a computer apparatus that operates in a case where a processor executes a program stored in a memory.

The point cloud generation apparatus 20 includes a light source unit 21, an optical modulation unit 22, a transmission unit 23, a reception unit 24, a coherent reception unit 25, a time information addition unit 26, a distance measurement unit 27, a speed calculation unit 28, and an output unit 29, as components. The component constituting the point cloud generation apparatus 20 may be a software component or a module whose processing is carried out by causing the processor to execute the program stored in the memory. Alternatively, the component constituting the point cloud generation apparatus 20 may be a hardware component such as a circuit or a chip.

The light source unit 21 may be used as means for generating a light source that outputs light. The optical modulation unit 22 may be used as means for modulating light. The transmission unit 23 may be used as means for transmitting the optical signal. The reception unit 24 may be used as means for receiving the optical signal. The coherent reception unit 25 may be used as means for receiving the optical signal using a coherent method. The time information addition unit 26 may be used as means for adding time information. The distance measurement unit 27 may be used as means for measuring a distance. The speed calculation unit 28 may be used as means for calculating a speed. The output unit 29 may be used as means for outputting information.

The optical modulation unit 22 modulates light output from the light source unit 21. For example, the optical modulation unit 22 may generate an optical signal indicating an optical pulse, by modulating a phase of the light. The transmission unit 23 transmits the optical signal to a target object 40. The optical signal transmitted to the target object 40 may be referred to as emitted light.

The target object 40 may be a stationary object that is stationary or may be a moving object that is moving. The stationary object may be a building, a road sign, a signal, or the like. The moving object may be a vehicle, a pedestrian, or the like.

The reception unit 24 receives an optical signal reflected by the target object 40. The reflected optical signal may be referred to as reflected light. Receiving the optical signal may be accepting or receiving the reflected light.

The coherent reception unit 25 extracts pulse information by causing the optical signal that is the reflected light and the light output from the light source unit 21 to interfere with each other. The pulse information is pulse information used in a case where the optical modulation unit 22 generates the optical signal indicating the optical pulse.

The time information addition unit 26 adds the time information to the pulse information extracted by the coherent reception unit 25. The time information may be, for example, a time when the time information addition unit 26 receives the pulse information from the coherent reception unit 25. Alternatively, the time information may be a time when the reception unit 24 receives the reflected light. In a case where the time information is the time when the reception unit 24 receives the reflected light, the reception unit 24 associates information indicating the time when the reflected light is received with the reflected light. The time when the reflected light is received may be associated with the reflected light, for example, as time stamp information set by the reception unit 24.

The distance measurement unit 27 measures a distance between the point cloud generation apparatus 20 and the target object 40. Specifically, the distance measurement unit 27 measures a distance between the point cloud generation apparatus 20 and a position where the optical signal transmitted from the point cloud generation apparatus 20 is reflected by the target object 40. For example, the distance measurement unit 27 measures a distance to the target object 40 using a time from when the transmission unit 23 transmits the optical signal to a time when the reception unit 24 receives the reflected light. Specifically, the time when the transmission unit 23 transmits the optical signal is set to t1, and the time when the reception unit 24 receives the reflected light is set to t2. In this case, a distance D between the point cloud generation apparatus 20 and the target object 40 is calculated as D=speed of light×(t2−t1)/2. “/” indicates division.

The speed calculation unit 28 calculates a speed of a point (reflection point) indicating a position where the optical signal transmitted from the point cloud generation apparatus 20 is reflected by the target object 40. The speed calculation unit 28 calculates the speed of the reflection point, based on a shift amount of a frequency of the optical signal transmitted from the transmission unit 23. The shift amount of the frequency may be, for example, a value indicating a difference between a frequency of the optical signal transmitted from the transmission unit 23 and a frequency of the reflected light received by the reception unit 24. The shift amount of the frequency may be referred to as a Doppler shift amount.

Here, calculation of the speed using the shift amount of the frequency will be described. First, a frequency fr of the reflected light is calculated by the following formula (1), using a relational expression of the Doppler effect.

$$fr = f𝔱 ( \frac{1 + v / c}{1 - v / c} ) \qquad Formula ( 1 )$$

Here,

c: light speed

v: relative speed between point cloud generation apparatus 20 and target object 40

ft: frequency of optical signal transmitted from transmission unit 23.

Next, a doppler shift amount fd is calculated using the following formula (2)

$$fd = fr - ft - 2 v ( \frac{ft}{c - v} ) \qquad Formula ( 2 )$$

A relative speed v is sufficiently smaller than a light speed c. Therefore, the formula (2) may be approximately calculated as the following formula (3).

$$fd \approx \frac{2 vft}{c} \qquad Formula ( 3 )$$

As a result, the relative speed v is calculated as indicated by the following formula (4).

$$v \approx \frac{c}{2} \cdot \frac{fd}{ft} \qquad Formula ( 4 )$$

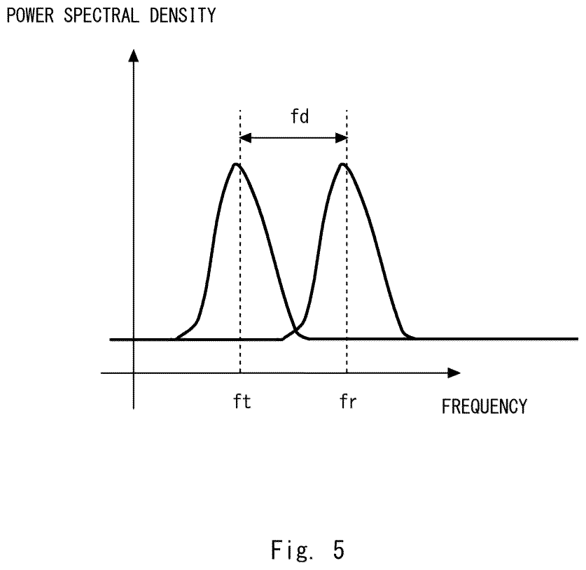

A frequency ft and the frequency fr may be specified by using power spectrum of the optical signal transmitted from the transmission unit 23 and the optical signal received by the reception unit 24. FIG. 5 is a diagram illustrating the power spectra of the optical signal transmitted from the transmission unit 23 and the optical signal received by the reception unit 24. As illustrated in FIG. 5, the frequency ft of a signal obtained in a case where a relative speed between the point cloud generation apparatus 20 and the target object 40 is 0 shifts to the frequency fr, if the relative speed changes. The change in the relative speed occurs, for example, in a case where the point cloud generation apparatus 20 is stationary and the target object 40 moves. Alternatively, the change in the relative speed occurs in a case where the speed of the point cloud generation apparatus 20 and the speed of the target object 40 are different. Alternatively, the change in the relative speed occurs in a case where the point cloud generation apparatus 20 moves and the target object 40 is stationary.

For example, the speed calculation unit 28 may derive or calculate the power spectrum by performing fast Fourier transform (FFT) analysis regarding the optical signal transmitted from the transmission unit 23 and the reflected light received by the reception unit 24.

The output unit 29 transmits three-dimensional information, the time information, and speed information of each point constituting the point cloud data to the point cloud processing apparatus 30.

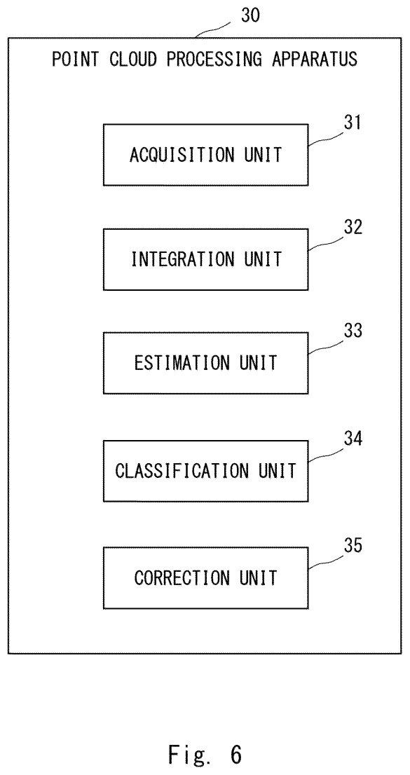

Subsequently, the point cloud processing apparatus 30 will be described. FIG. 6 illustrates a configuration example of the point cloud processing apparatus 30. The point cloud processing apparatus 30 corresponds to the point cloud processing apparatus 10. Detailed description of configurations, functions, and the like of the point cloud processing apparatus 30 similar to those of the point cloud processing apparatus 10 are omitted.

The point cloud processing apparatus 30 includes an acquisition unit 31, an integration unit 32, an estimation unit 33, a classification unit 34, and a correction unit 35. The acquisition unit 31 corresponds to the acquisition unit 11 in the point cloud processing apparatus 10. The estimation unit 33 corresponds to the estimation unit 12 in the point cloud processing apparatus 10. The estimation unit 33 corresponds to the correction unit 13 in the point cloud processing apparatus 10. The integration unit 32 may be used as means for integrating information. The classification unit 34 may be used as means for classifying information.

The acquisition unit 31 acquires the point cloud data from the point cloud generation apparatus 20. Each point of the point cloud data is associated with time information indicating a time when each point is generated and the speed information. The time when each point is generated may be a time when the point cloud generation apparatus 20 receives the reflected light, a time when the point cloud generation apparatus 20 executes coherent reception processing regarding the reflected light, or the like.

The integration unit 32 integrates the pieces of point cloud data generated at different timings. Integrating may be rephrased as combining, coupling, superimposing, adding, or the like. By integrating the pieces of point cloud data generated at the different timings, the shape of the stationary object is accurately indicated. Accurately indicating the shape may mean that the shape is indicated to be recognizable. Alternatively, accurately indicating the shape may mean that a boundary between an object and another object is clear.

On the other hand, in a case where point cloud data of the moving object that is moving is generated, even if the pieces of point cloud data generated at the different timings are integrated, the shape of the moving object is not clearly indicated.

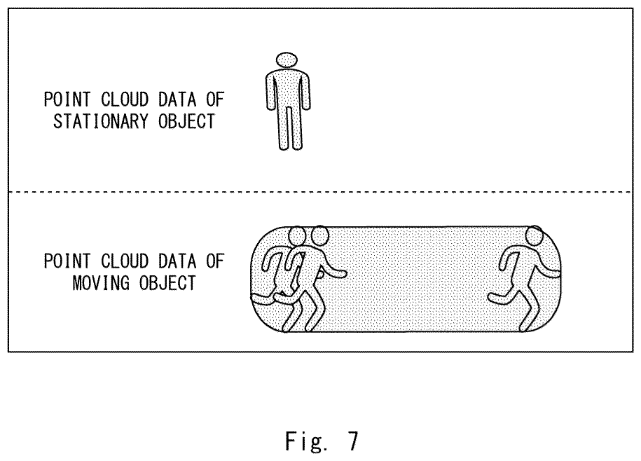

FIG. 7 illustrates point cloud data of the stationary object and point cloud data of the moving object. The stationary object indicates a person who is stationary, and the moving object indicates a moving person. Regarding the point cloud data of the stationary object, by integrating the pieces of point cloud data generated at the different timings, the shape of the stationary object is accurately indicated.

On the other hand, by integrating the pieces of point cloud data generated at the different timings, the point cloud data of the moving object is point cloud data of a shape elongated in a traveling direction of the moving object. The point cloud data having the elongated shape may be a rectangle, a rectangle with rounded apex portions, an ellipse, a shape having a curve, or the like. A shape of the person indicated in the point cloud data of the moving object is indicated to describe that the person is moving, and the shape of the person is not accurately indicated in the point cloud data having the elongated shape.

The estimation unit 33 estimates a speed of the moving object. For example, the estimation unit 33 estimates the speed using the point cloud data included in the elongated shape. Each point included in the elongated shape is associated with the speed information. In a case where the moving object moves at a constant speed, the speed information associated with each point has substantially the same value. Substantially the same value may vary within a predetermined range. The estimation unit 33 may estimate speed information associated with any point included in the elongated shape as the speed of the moving object. Alternatively, the estimation unit 33 may estimate an average value, a maximum value, or a minimum value of the speeds of any number of points included in the elongated shape as the speed of the moving object. Alternatively, the estimation unit 33 may estimate an average value, a maximum value, or a minimum value of the speeds of all the points included in the elongated shape as the speed of the moving object. Alternatively, the estimation unit 33 may estimate a speed associated with a point at a position to be the center of gravity of the elongated shape as the speed of the moving object.

The classification unit 34 classifies an object for each speed. In other words, the classification unit 34 classifies or identifies objects with different speeds as different objects. Furthermore, the classification unit 34 may classify pieces of point cloud data with the same speed that are pieces of point cloud data existing at positions away from each other by a predetermined distance or more, as different objects. Furthermore, the classification unit 34 may classify objects moving in different directions, as different objects.

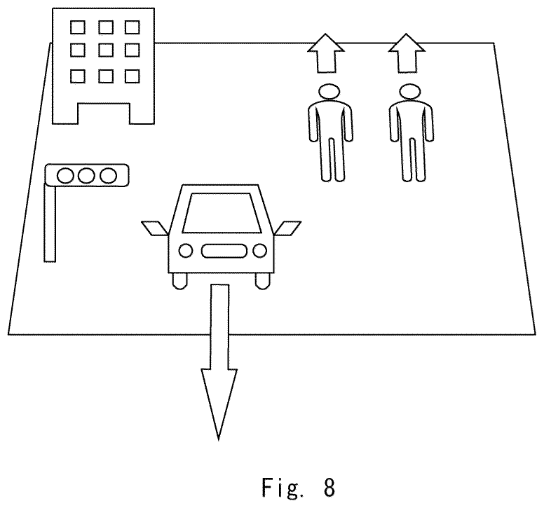

FIG. 8 illustrates a person and a vehicle as the moving objects. It is illustrated that the person moves upward in FIG. 8 and the vehicle moves downward in FIG. 8. Furthermore, it is assumed that an arrow indicate a moving direction and also indicate a speed. For example, it is assumed that the speed increase as a length of the arrow becomes long. FIG. 8 illustrates that a moving speed of the vehicle is faster than a moving speed of the person. Furthermore, it is assumed that moving speeds of the two persons be substantially the same.

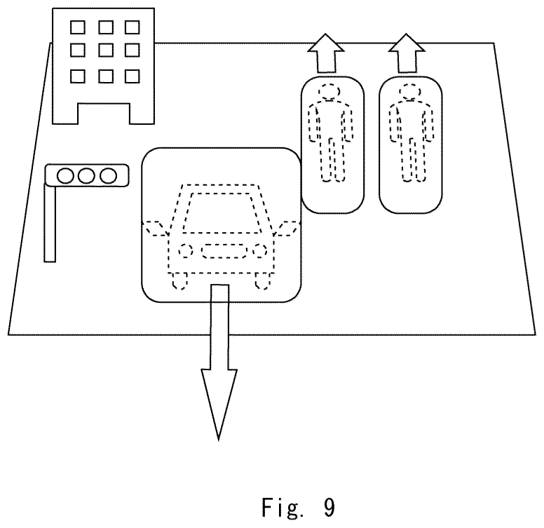

In a case where a relative speed between the point cloud generation apparatus 20 and the vehicle, and in addition, a relative speed between the point cloud generation apparatus 20 and the person change, the point cloud data generated by the point cloud generation apparatus 20 does not accurately indicate shapes of the vehicle and the person, as illustrated in FIG. 9. FIG. 9 illustrates that the vehicle and the person are included in a predetermined region. That is, FIG. 9 illustrates that the vehicle and the person move in the predetermined region. Although the vehicle and the person in FIG. 9 are illustrated using dotted lines, in practice, it is not possible to identify the shapes of the vehicle and the person, in the point cloud data illustrated in FIG. 9. In FIG. 9, in order to describe a region including the vehicle and a region including the person, the vehicle and the person are illustrated using dotted lines.

Since the person and the vehicle move at different speeds, the classification unit 34 classifies the region of the person and the region of the vehicle as different objects. Furthermore, as illustrated in FIG. 8, it is assumed that two persons move in the same direction and at substantially the same speed. In this case, in a case where regions indicating the persons are away from each other by a predetermined distance or more, the classification unit 34 classifies the regions as different objects.

Furthermore, a moving person often walks or runs swinging one's arms. In such a case, relative speeds between a torso, foot, arm of the person and the point cloud generation apparatus 20 are different from each other. In such a case, the classification unit 34 may further classify the point cloud data indicating the person for each part of the person such as a torso, foot, or arm.

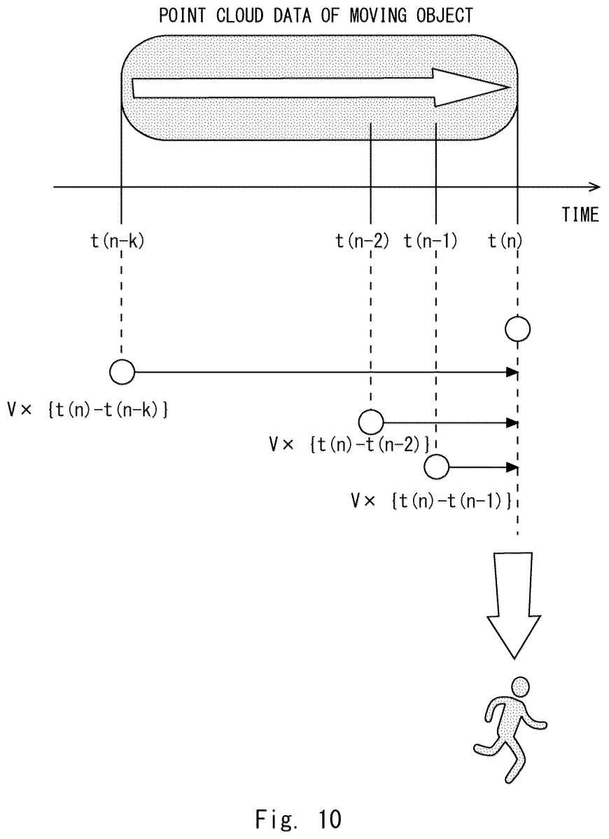

The correction unit 35 corrects the position of the point cloud data included in the moving object. Correcting the position of the point cloud data may be restoring the shape of the point cloud data indicating the moving object. Here, the correction of the position of the point cloud data will be described with reference to FIG. 10. FIG. 10 illustrates the point cloud data of the moving object. Specifically, in FIG. 10, a time when a point constituting the point cloud data indicating the moving object is generated is illustrated.

An open arrow in the point cloud data of the moving object indicates a moving direction of the moving object. In FIG. 10, a time t (n) is a latest time, and t (n−k) indicates an oldest time. The references n and k are integers equal to or more than 0. Circles connected to a time t (n−k), a time t (n−2), a time t (n−1), and a time t (n) using dotted lines indicate points included in the point cloud data of the moving object. That is, each point indicates a position in the point cloud data at each time.

Furthermore, a moving speed of the moving object is set to a speed V. The speed V may be a relative speed between the point cloud generation apparatus 20 and the moving object. Here, it is assumed that the correction unit 35 correct the position of the point cloud data of the moving object, so as to indicate a shape of the moving object at the time t (n). In this case, for example, the correction unit 35 moves a position of a point generated at the time t (n−k) in the traveling direction of the moving object by a distance indicated by the speed V×{t (n)−t (n−k)}. Moreover, the correction unit 35 moves a position of a point generated at the time t (n−2) in the traveling direction of the moving object by a distance indicated by the speed V×{t (n)−t (n−2)}. Moreover, the correction unit 35 moves a position of a point generated at the time t (n−1) in the traveling direction of the moving object by a distance indicated by the speed V×{t (n)−t (n−1)}. In this way, the correction unit 35 specifies a position of the point generated before the time t (n) estimated in a case where the point is moved to the time t (n). The correction unit 35 corrects the position, for all the points associated with the moving speed V.

By integrating the points of which the positions are corrected, as indicated below the arrow at the time t (n) in FIG. 10, the shape of the moving object is clearly indicated.

As described above, the point cloud processing apparatus 30 corrects the position of each point included in the point cloud indicating the moving object, using the speed information and the time information. As a result, the point cloud processing apparatus 30 can restore the shape of the moving object that is elongated and is not accurately indicated and generate the point cloud data with which the shape of the moving object can be recognized.

### Third Example Embodiment

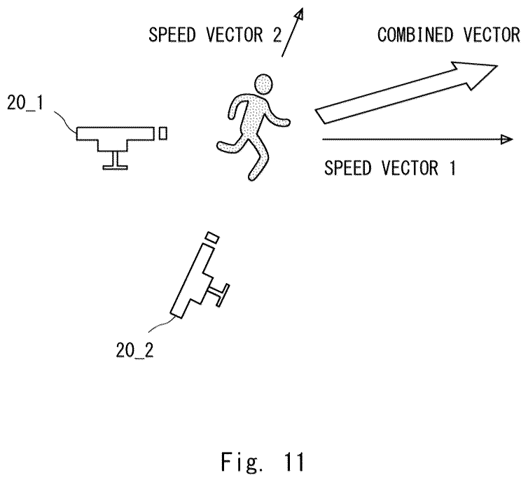

Subsequently, calculation of a speed of a moving object according to a third example embodiment will be described. FIG. 11 illustrates an example in which point cloud data of the moving object is generated using a plurality of point cloud generation apparatuses 20. In FIG. 11, as the plurality of point cloud generation apparatuses 20, a point cloud generation apparatus 20_1 and a point cloud generation apparatus 20_2 are used. However, three or more point cloud generation apparatuses 20 may be used.

In speed estimation using a Doppler shift amount, the point cloud generation apparatus 20_1 and the point cloud generation apparatus 20_2 can estimate a speed component in each line-of-sight direction. The line-of-sight direction may be rephrased as a measurement direction. That is, the line-of-sight direction may be a direction on a straight line connecting the point cloud generation apparatus 20_1 and a target object 40, and in addition, on a straight line connecting the point cloud generation apparatus 20_2 and the target object 40.

In FIG. 11, the point cloud generation apparatus 20_1 estimates a speed in a direction indicated by a speed vector 1, and the point cloud generation apparatus 20_2 estimates a speed in a direction indicated by a speed vector 2.

An estimation unit 33 may generate the speed vectors 1 and 2, using speed information received from the point cloud generation apparatuses 20_1 and 20_2. For example, it is assumed that the estimation unit 33 have information regarding the line-of-sight directions of the point cloud generation apparatuses 20_1 and 20_2, in advance. Alternatively, the estimation unit 33 may receive the information regarding the line-of-sight direction, from the point cloud generation apparatuses 20_1 and 20_2. The estimation unit 33 may generate the speed vectors 1 and 2, by combining the information regarding the line-of-sight directions of the point cloud generation apparatuses 20_1 and 20_2 and the speed information in each of the directions.

Moreover, the estimation unit 33 generates a combined vector illustrated in FIG. 11, by combining the speed vectors 1 and 2.

As described above, by combining the pieces of speed information estimated by the plurality of point cloud generation apparatuses 20, a moving direction of the target object 40 can be accurately estimated. As a result, accuracy of a shape of the target object 40 indicated by a shape of corrected point cloud data generated by a correction unit 35 is improved as compared with a case of using the single point cloud generation apparatus 20.

### Fourth Example Embodiment

Subsequently, calculation of a speed of a moving object according to a fourth example embodiment will be described. In the fourth example embodiment, it is assumed that speed information be not associated with each point constituting point cloud data. That is, in the fourth example embodiment, a case will be described where a point cloud generation apparatus 20 does not have a function for estimating the speed of the moving object.

FIG. 12 illustrates point cloud data in which point clouds measured from a time t (n−k) to a time t (n) are stacked. It is assumed that the point cloud data in which the point clouds measured from the time t (n−k) to the time t (n) are stacked indicate a moving object. Furthermore, an open arrow indicated in the point cloud data indicates a moving direction of the moving object. The moving direction may be, for example, a direction of a first principal component obtained by performing principal component analysis on each point included in the point cloud data.

Furthermore, FIG. 12 illustrates point cloud data in which point clouds measured during Δt from the time t (n−k) are stacked and point cloud data in which point clouds measured during Δt to the time t (n) are stacked. An estimation unit 33 may estimate a speed of the point cloud data, based on a movement distance of the point cloud data and a time required for movement.

For example, the estimation unit 33 may specify a point of the center of gravity in the point cloud data during Δt from the time t (n−k) and a point of the center of gravity in the point cloud data during Δt to the time t (n). The estimation unit 33 may estimate a speed of the point of the center of gravity calculated based on a movement distance of the point of the center of gravity and a time required for movement of the point of the center of gravity, as the speed of the moving object.

The movement distance of the point of the center of gravity is specified from coordinates of the point of the center of gravity. Furthermore, the time required for the movement of the point of the center of gravity may be, for example, t (n)−t (n−k)−Δt or may be approximated as t (n)−t (n−k) with Δt being a sufficiently small value.

The estimation unit 33 may use any point in the point cloud data during Δt from the time t (n−k) and any point in the point cloud data during Δt to the time t (n), instead of using the point of the center of gravity.

As described above, even in a case where the point cloud generation apparatus 20 does not have the function for estimating the speed of each point, the speed of the moving object can be estimated, using the movement distance of the point included in the point cloud data stacked in a predetermined time and the time required for the movement.

### Fifth Example Embodiment

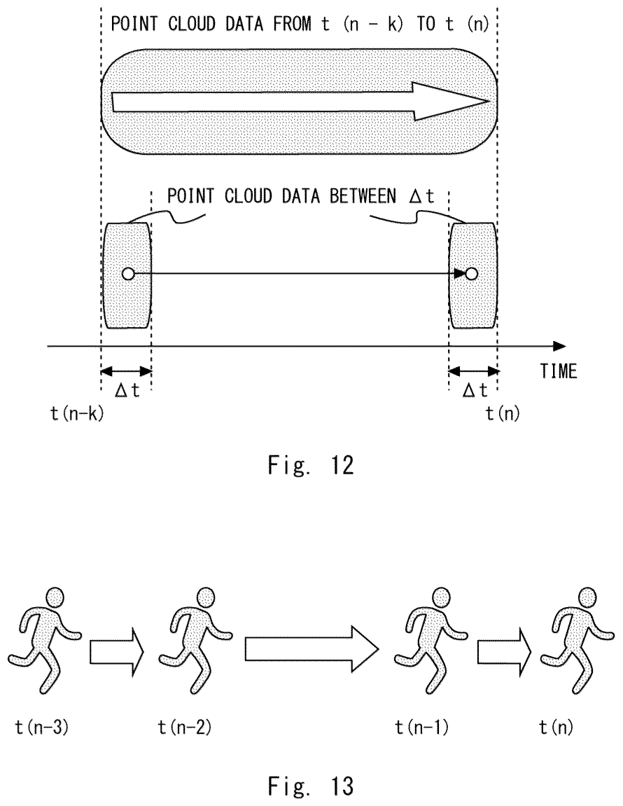

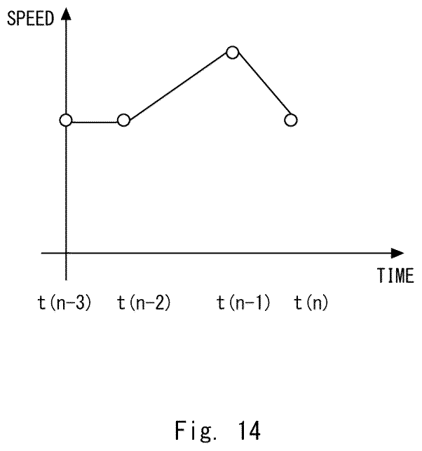

Subsequently, correction of a position of point cloud data according to a fifth example embodiment will be described. Here, as illustrated in FIG. 13, the correction of the position of the point cloud data in a case where a speed changes instead of a constant speed in a case where a moving object moves from a time t (n−3) to a time t (n) will be described.

It is assumed that time intervals of respective sections divided at t (n), t (n−1), t (n−2), and t (n−3) in FIG. 13 be the same. In FIG. 13, since a movement distance in the section from t (n−2) to t (n−1) is longer than the other sections, a speed in the section from t (n−2) to t (n−1) is set to be faster than the other sections.

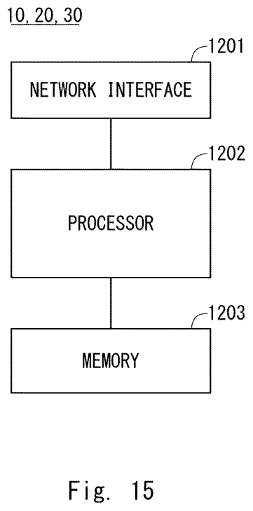

FIG. 14 illustrates a change in a moving speed illustrated in FIG. 13 as a graph. In such a situation, in a case where pieces of point cloud data generated at t (n−3), t (n−2), and t (n−1) are corrected to a position at t (n), the position is corrected according to the following formula (5).

$${R}^{′} ( n ) = R ( n - k ) + {\sum }_{m = 1}^{k} \{ v ( n - m \} \cdot ( t ( n - m + 1 ) - t ( n - m ) ) \} \qquad Formula ( 5 )$$

Here,

R (n−k): coordinates before correction of point cloud data acquired at time t (n−k)

R′ (n): coordinates after correction at time t (n) of point cloud data acquired at time t (n−k)

v (n−m): speed of target object calculated at time t (n−m).

In this way, in a case of correcting the point cloud data, the estimation unit 33 can more accurately estimate a position of the corrected point cloud data, by correcting the point cloud data, in consideration of the speed that changes for each time.

FIG. 15 is a block diagram illustrating a configuration example of a point cloud processing apparatus 10, a point cloud generation apparatus 20, and a point cloud processing apparatus 30 (hereinafter, referred to as point cloud processing apparatus 10 or the like). Referring to FIG. 15, the point cloud processing apparatus 10 or the like includes a network interface 1201, a processor 1202, and a memory 1203. The network interface 1201 may be used to communicate with a network node. The network interface 1201 may include, for example, a network interface card (NIC) conforming to IEEE 802.3 series. The IEEE represents Institute of Electrical and Electronics Engineers.

The processor 1202 executes processing of the point cloud processing apparatus 10 or the like described with reference to the flowchart, by reading and executing a software component (computer program) from the memory 1203. The processor 1202 may be, for example, a microprocessor, a micro processing unit (MPU), or a central processing unit (CPU). The processor 1202 may include a plurality of processors.

The memory 1203 includes a combination of a volatile memory and a nonvolatile memory. The memory 1203 may include a storage disposed away from the processor 1202. In this case, the processor 1202 may access the memory 1203 through an input/output (I/O) interface (not illustrated).

In the example in FIG. 15, the memory 1203 is used to store a software module group. The processor 1202 can execute the processing of the point cloud processing apparatus 10 or the like, by reading and executing these software module group from the memory 1203.

As described with reference to FIG. 15, each of the processors included in the point cloud processing apparatus 10 or the like executes one or a plurality of programs including a command group for causing a computer to perform an algorithm described with reference to the drawings.

In the example described above, the program includes a group of commands (or software codes) for causing a computer to execute one or more functions described in the example embodiments in a case where the program is read by the computer. The program may be stored in a non-transitory computer-readable medium or a tangible storage medium. As an example and not by way of limitation, the computer-readable medium or the tangible storage medium includes a random access memory (RAM), a read only memory (ROM), a flash memory, a solid-state drive (SSD) or any other memory technology, a CD-ROM, a digital versatile disc (DVD), a Blu-ray (registered trademark) disc or any other optical disk storage, a magnetic cassette, a magnetic tape, a magnetic disk storage, or any other magnetic storage device. The program may be transmitted on a transitory computer-readable medium or a communication medium. By way of example, and not limitation, a transitory computer-readable medium or a communication medium includes electrical, optical, acoustic, or other forms of propagated signals.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with at least one of embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example, to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

Some or all of the above-described example embodiments may be described as in the following Supplementary Notes, but are not limited to the following Supplementary Notes.

### (Supplementary Note 1)

A point cloud processing apparatus including:

acquisition means for acquiring first point cloud data generated by measuring a space including a moving object for a predetermined period;

estimation means for estimating speed information of the moving object, based on second point cloud data constituting the moving object, the second point cloud data being included in the first point cloud data; and

a correction unit configured to correct a position of the second point cloud data using the speed information and difference information between a time when the second point cloud data is generated and a reference time.

### (Supplementary Note 2)

The point cloud processing apparatus according to Supplementary Note 1, in which

the first point cloud data includes distance information to an object specified based on an optical signal transmitted to the space and reflected light in a case where the optical signal is reflected by the object existing in the space, and

the estimation means

estimates the speed information, based on frequency information of first reflected light in a case where the optical signal is reflected by the moving object.

### (Supplementary Note 3)

The point cloud processing apparatus according to Supplementary Note 2, in which the estimation means estimates the speed information, based on frequency information of the optical signal transmitted to the space and the frequency information of the first reflected light.

### (Supplementary Note 4)

The point cloud processing apparatus according to Supplementary Note 3, in which the estimation means estimates the speed information, based on a shift amount of a frequency calculated from the frequency information of the optical signal and the frequency information of the first reflected light.

### (Supplementary Note 5)

The point cloud processing apparatus according to Supplementary Note 1, in which the estimation means estimates the speed information based on a distribution of the second point cloud data in the predetermined period.

### (Supplementary Note 6)

The point cloud processing apparatus according to any one of Supplementary Notes 1 to 5, in which the estimation means associates the second point cloud data with the speed information.

### (Supplementary Note 7)

The point cloud processing apparatus according to any one of

Supplementary Notes 1 to 6, in which

the acquisition means

acquires a plurality of pieces of the first point cloud data generated by measuring the space at different positions, and

the estimation means

combines a plurality of pieces of the speed information of the moving object estimated based on each of the pieces of first point cloud data.

### (Supplementary Note 8)

The point cloud processing apparatus according to any one of Supplementary Notes 1 to 7, further including classification means for classifying each of the moving objects based on the speed information, in a case where a plurality of the moving objects exists in the space.

### (Supplementary Note 9)

The point cloud processing apparatus according to any one of Supplementary Notes 1 to 8, in which the correction unit corrects a position of the second point cloud data at the time when the second point cloud data is generated to a position of the second point cloud data at the reference time.

### (Supplementary Note 10)

A point cloud processing system including:

a point cloud generation apparatus configured to generate first point cloud data by measuring a space including a moving object for a predetermined period; and

a point cloud processing apparatus configured to acquire the first point cloud data, estimate speed information of the moving object based on second point cloud data included in the first point cloud data that is the second point cloud data constituting the moving object, and correct a position of the second point cloud data, using the speed information and difference information between a time when the second point cloud data is generated and a reference time.

### (Supplementary Note 11)

A data processing method including:

acquiring first point cloud data generated by measuring a space including a moving object for a predetermined period;

estimating speed information of the moving object, based on second point cloud data constituting the moving object, the second point cloud data being included in the first point cloud data; and

correcting a position of the second point cloud data using the speed information and difference information between a time when the second point cloud data is generated and a reference time.

### (Supplementary Note 12)

A program for causing a computer to execute processing including:

acquiring first point cloud data generated by measuring a space including a moving object for a predetermined period;

estimating speed information of the moving object, based on second point cloud data constituting the moving object, the second point cloud data being included in the first point cloud data; and

correcting a position of the second point cloud data using the speed information and difference information between a time when the second point cloud data is generated and a reference time.

Some or all of the elements (such as configurations and functions, for example) described in Supplementary Notes 2 to 9 depending from Supplementary Note 1 may depend from Supplementary Notes 10 to 12 as well with depending relationships similar to those of Supplementary Notes 2 to 9. Some or all of the elements described in any Supplementary Note may be applied to various types of hardware components, software components, recording means for recording software components, systems, and methods.

What is claimed is:

1. A point cloud processing apparatus comprising:
at least one memory storing instructions; and
at least one processor configured to execute the instructions to:
acquire first point cloud data generated by measuring a space including a moving object for a predetermined period;
estimate speed information of the moving object, based on second point cloud data constituting the moving object, the second point cloud data being included in the first point cloud data; and
correct a position of the second point cloud data using the speed information and difference information between a time when the second point cloud data is generated and a reference time.

2. The point cloud processing apparatus according to claim 1, wherein
the first point cloud data includes distance information to an object specified based on an optical signal transmitted to the space and reflected light in a case where the optical signal is reflected by the object existing in the space, and
the at least one processor is further configured to execute the instructions to estimate the speed information, based on frequency information of first reflected light in a case where the optical signal is reflected by the moving object.

3. The point cloud processing apparatus according to claim 2, wherein the at least one processor is further configured to execute the instructions to estimate the speed information, based on frequency information of the optical signal transmitted to the space and the frequency information of the first reflected light.

4. The point cloud processing apparatus according to claim 3, wherein the at least one processor is further configured to execute the instructions to estimate the speed information, based on a shift amount of a frequency calculated from the frequency information of the optical signal and the frequency information of the first reflected light.

5. The point cloud processing apparatus according to claim 1, wherein the at least one processor is further configured to execute the instructions to estimate the speed information based on a distribution of the second point cloud data in the predetermined period.

6. The point cloud processing apparatus according to claim 1, wherein the at least one processor is further configured to execute the instructions to associate the second point cloud data with the speed information.

7. The point cloud processing apparatus according to claim 1, wherein the at least one processor is further configured to execute the instructions to acquire a plurality of pieces of the first point cloud data generated by measuring the space at different positions, and combine a plurality of pieces of the speed information of the moving object estimated based on each of the pieces of first point cloud data.

8. The point cloud processing apparatus according to claim 1, wherein the at least one processor is further configured to execute the instructions to classify each of the moving objects based on the speed information, in a case where a plurality of the moving objects exists in the space.

9. The point cloud processing apparatus according to claim 1, wherein the at least one processor is further configured to execute the instructions to correct a position of the second point cloud data at the time when the second point cloud data is generated to a position of the second point cloud data at the reference time.

10. A data processing method comprising:
acquiring first point cloud data generated by measuring a space including a moving object for a predetermined period;
estimating speed information of the moving object, based on second point cloud data constituting the moving object, the second point cloud data being included in the first point cloud data; and
correcting a position of the second point cloud data using the speed information and difference information between a time when the second point cloud data is generated and a reference time.

11. A non-transitory computer readable medium storing a program for causing a computer to execute processing comprising:
acquiring first point cloud data generated by measuring a space including a moving object for a predetermined period;
estimating speed information of the moving object, based on second point cloud data constituting the moving object, the second point cloud data being included in the first point cloud data; and
correcting a position of the second point cloud data using the speed information and difference information between a time when the second point cloud data is generated and a reference time.
